(19) United States
(12) Patent Application Publication
(10) Pub. No.: US 2009/0013772 A1
(43) Pub. Date: Jan. 15, 2009

(54) METHOD FOR DETERMINING COMBUSTION STATE OF INTERNAL COMBUSTION ENGINE

(75) Inventors: Morito ASANO, Osaka (JP); Yoshiyuki FUKUMURA, Osaka (JP); Mitsuhiro IZUMI, Osaka (US); Kouichi KITAURA, Aichi-ken (JP); Kouichi SATOYA, Aichi-ken (JP); Mamoru YOSHIOKA, Aichi-ken (JP)

Correspondence Address: BANNER & WITCOFF, LTD., 1100 13th STREET, N.W., SUITE 1200, WASHINGTON, DC, 20005-4051, US

(73) Assignees: DAIHATSU MOTOR CO., LTD., Osaka (JP); DIAMOND ELECTRIC MFG. CO., LTD., Osaka (JP); TOYOTA JIDOSHA KABUSHIKI KAISHA, Aichi-ken (JP)

(21) Appl. No.: 12/278,365

(22) PCT Filed: Jan. 31, 2007
(86) PCT No.: PCT/JP2007/051552

§ 371 Date: Aug. 5, 2008

(30) Foreign Application Priority Data
Jun. 2, 2006 (JP) 2006-028124

(51) Int. Cl. G01M 15/04

(52) U.S. Cl. 73/114.67

(57) ABSTRACT

The invention relates of a method for determining a combustion state of an internal combustion engine, for detecting an ion current generated within a combustion chamber of the internal combustion engine, including the steps of measuring a characteristic value of the ion current detected during a period that the ion current is generated and a generation period in which the ion current is generated, and determining a combustion state on the basis of a relation between the characteristic value and the generation period with respect to an elapsed time from an ignition, and the method comprises determining that the combustion state is normal, by setting a determination reference to be larger with respect to the characteristic value and shorter with respect to the generation period, in the case that the elapsed time from the ignition is short, and determining that the combustion is normal, by setting the determination reference to be smaller with respect to the characteristic value and longer with respect to the generation period in correspondence that the elapsed time from the ignition becomes longer.

### TECHNICAL FIELD

The present invention relates to a method for determining a combustion state of an internal combustion engine having a structure which can determine a combustion state of the internal combustion engine on the basis of an ion current generated within a combustion chamber.

### BACKGROUND ART

Conventionally, in an internal combustion engine (hereinafter, refer to as an engine) mounted to a vehicle, it is attempted to determine a combustion state by detecting an ion current generated within a combustion chamber. Specifically, the ion current is detected on the basis of a fact that the ion current generated in the combustion chamber after an ignition exceeds a threshold level which is set for detection, and it is determined that the combustion state is good in the case of detecting the ion current.

In this case, in the structure detecting the ion current by using the threshold level as mentioned above, there is a case that a current value of the ion current is greater than the threshold level by a superimposition of a noise on the ion current in a combustion state in which only the ion current not being greater than the threshold level is actually generated, and it is determined to be good on the basis of the state of the ion current on which the noise is superimposed, in spite of the operating state which is not good. In order to prevent the erroneous determination mentioned above from being generated, for example, the structure described in Patent Document 1 employs a structure which generates a threshold level in a steady state and a threshold value in a high rotating state or a high load state having a higher value than the threshold level in the steady state, and detects the ion current on the basis of the threshold level in correspondence to the operating state of the engine.

Patent Document 1: Japanese Patent No. 2552754

In this case, in the ion current, it is known that a generating time becomes elongated and a maximum current value becomes lower, in accordance with a spark retard of an ignition timing. In other words, in the case that the engine is operated by setting the ignition timing to a spark advance near a stoichiometric air fuel ratio, the ion current becomes maximum near a maximum of a combustion pressure (in an initial stage of the combustion), and is attenuated comparatively rapidly thereafter, however, if the ignition timing is retarded, the timing at which the current value becomes maximum gives way to a second stage of the combustion or the current value to be maximum becomes lowered, so that a time until disappearing is elongated by attenuating slowly.

Further, in the case that the combustion is unstable in a state in which the air fuel ratio becomes excessively higher, that is, in an excessively lean state, the current value of the ion current does not become significantly maximum as mentioned above, and there is a case that the ion current is generated for a long time while keeping the low current value. If the ignition timing is retarded in the case mentioned above, a so-called after burning is generated, and there is a case that the current value of the ion current becomes higher in the second stage of the combustion in a state in which the combustion is unstable.

With regard to a behavior of the ion current as mentioned above, in accordance with the structure described in Patent Document 1 mentioned above, since the structure is made such as to detect the ion current by using one kind of threshold level with respect to each of the steady state, and the high rotating speed state or the high load state, there is a case that it is hard to detect the ion current in the case that the ignition timing is retarded. In other words, as described above, if the ignition timing is retarded, the current value of the ion current becomes lowered. Accordingly, there is a case that the current value of the ion current does not come to the value which is greater than the threshold value, it is impossible to detect the ion current, and there is a possibility that it is impossible to determine the combustion state.

Further, if the generated ion current exceeds the threshold level in the steady state even in the case that the combustion becomes unstable, the ion current is detected in the same manner as the case of the normal combustion state. Accordingly, in spite that the combustion state is actually unstable, the normal combustion state is determined from the result of detection of the ion current, and it is hard to discriminate the normal combustion state and the unstable combustion state.

### DISCLOSURE OF THE INVENTION

Accordingly, an object of the present invention is to dissolve the problem mentioned above.

In other words, in accordance with the present invention, there is provided a method for determining a combustion state of an internal combustion engine, for detecting an ion current generated within a combustion chamber of the internal combustion engine, comprising the steps of: measuring a characteristic value of the ion current detected during a period that the ion current is generated and a generation period in which the ion current is generated; and determining a combustion state on the basis of a relation between the characteristic value and the generation period with respect to an elapsed time from an ignition, wherein the method comprises determining that the combustion state is normal, by setting a determination reference to be larger with respect to the characteristic value and shorter with respect to the generation period, in the case that the elapsed time from the ignition is short, and determining that the combustion is normal, by setting the determination reference to be smaller with respect to the characteristic value and longer with respect to the generation period in correspondence that the elapsed time from the ignition becomes longer.

In the present invention, the characteristic value of the ion current indicates a current value of the ion current, and a voltage value generated by the ion current.

In the structure mentioned above, it is possible to determine the combustion state in correspondence to various operating states, by structuring the determination reference by one with respect to the generation period of the ion current and other with respect to the characteristic value, and changing each of them in correspondence to the elapsed time from the ignition. In other words, in the case that the elapsed time from the ignition is short, it is possible to determine a good combustion state by detecting a great characteristic value in a short generation period, by setting the one with respect to the characteristic value of the ion current large and setting the other with respect to the generation period short. Further, since the combustion state is determined on the basis of the determination reference in which the one with respect to the characteristic value is decreased in accordance that the elapsed time becomes longer and the other with respect to the generation period is set long, it is possible to determine the good combustion even if the case that the ignition timing is retarded is lowered in comparison with the case that the characteristic value of the ion current is not retarded. Accordingly, in the case that the ignition timing is retarded, for example, for increasing the temperature of the catalyst at an engine start or the like, it is possible to prevent the combustion state from being erroneously determined.

Further, in accordance with the present invention, there is provided a method for determining a combustion state of an internal combustion engine, for detecting an ion current generated within a combustion chamber of the internal combustion engine, comprising the steps of: setting at least two determination values having different magnitudes; individually measuring a generation period in which a current value of the detected ion current is greater than each of the determination values; and determining that the combustion state is normal in the case that a generation period measured in the case that the detected ion current is greater than only a determination value which is lower than a highest determination value in the determination values is longer than a generation period measured on the basis of the highest determination value.

With this structure, it is possible to determine the combustion state corresponding to the various operating states by using at least two determination values having the different magnitudes. In this case, since it is sufficient to set at least two determination values, it is possible to simplify the structure of a determination circuit of the ion current and a control program for determining. Further, it is possible to determine that the combustion state is normal even if the current value of the ion current becomes lower in the case that the ignition timing is retarded, by setting the low determination value.

In the structure mentioned above, in order to accurately determine the case that the combustion state is unstable, it is preferable to determine that the combustion state is unstable in the case of measuring the period only on the basis of the low determination value in a first stage of the combustion and thereafter measuring the period on the basis of the highest determination value in a second stage of the combustion.

The present invention is structured as described above, and even if the characteristic vale of the ion current and the generation period generating the ion current are different in correspondence to the various operating states, the present invention can accurately determine the combustion state on the basis of the ion current. Particularly, even in the case that the characteristic value of the ion current becomes smaller by setting the ignition timing to the spark retard, it is possible to properly determine the combustion state by determining the characteristic value and the generation period.

### BRIEF DESCRIPTION OF THE DRAWINGS

FIG. 1 is an explanatory view of a structure showing an schematic structure of an engine in accordance with an embodiment of the present invention.

FIG. 2 is graph showing an ion current wave form in the case that a combustion state of the embodiment is different.

FIG. 3 is a flow chart showing a control procedure of the embodiment.

### BEST MODE FOR CARRYING OUT THE INVENTION

One embodiment of the present invention will be described below with reference to the drawings.

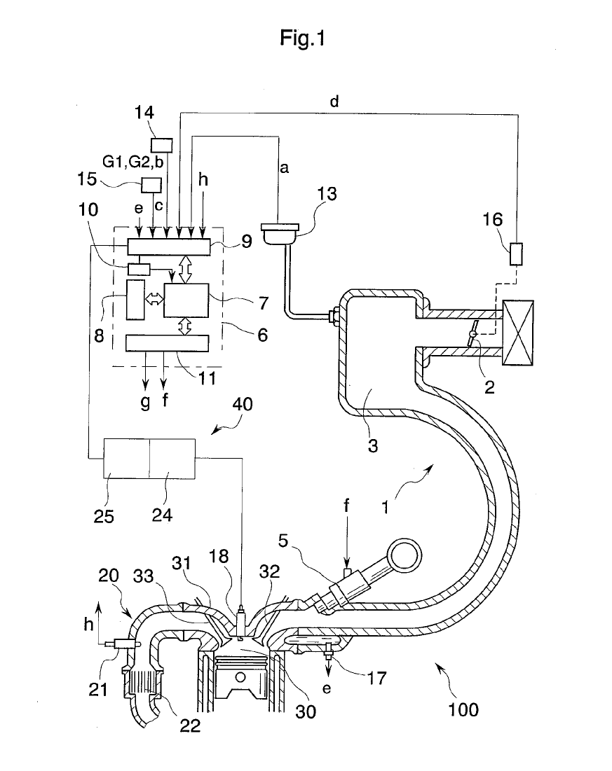

An engine 100 schematically shown in FIG. 1 is of a spark ignition type four cycle four cylinder engine for a motor vehicle, and is structured such that a throttle valve 2 opening and closing in response to an accelerator pedal (not shown) is arranged in an intake system 1, and a surge tank 3 is provided in a downstream side of the throttle valve 2. A fuel injection valve 5 is further provided near one end portion communicating with the surge tank 3, and the fuel injection valve 5 is structured such as to be controlled by an electronic control device 6. An intake valve 32 and an exhaust valve 33 are arranged in a cylinder head 31 forming a combustion chamber 30, and a spark plug 18 forming an electrode for generating a spark and detecting an ion current I is attached to the cylinder head 31. Further, an O₂ sensor 21 for measuring an oxygen concentration in the exhaust gas is attached to an upstream position of a three-way catalyst 22 corresponding to a catalyst device arranged in a pipe line until reaching a muffler (not shown), in the exhaust system 20. Here, FIG. 1 illustrates as a representative of a structure of one cylinder of the engine 100.

The electronic control device 6 is mainly constructed by a microcomputer system which includes a central processing unit 7, a memory device 8, an input interface 9, an output interface 11, and an A/D converter 10. To the input interface 9, there are input an intake pressure signal a which is output from an intake air pressure sensor 13 for detecting a pressure within the surge tank 3, that is, an intake pipe pressure, a cylinder determination signal G1, a crank angle reference position signal G2 and an engine rotating speed signal b which are output from a cam position sensor 14 for detecting a rotating state of the engine 100, a vehicle speed signal c which is output from a vehicle speed sensor 15 for detecting a vehicle speed, an IDL signal d which is output from an idle switch 16 for detecting an opened and closed state of the throttle valve 2, a water temperature signal e which is output from a water temperature sensor 17 for detecting a cooling water temperature of the engine 100, a current signal h which is output from the above O₂ sensor 21 and the like. On the other hand, a fuel ignition signal f is output to the fuel injection valve 5, and an ignition pulse g is output to a spark plug 18, from the output interface 11.

A power supply 24 for bias for measuring an ion current I is connected to the spark plug 18, and a circuit 25 for measuring the ion current is connected between the input interface 9 and the bias power supply 24. An ion current detection system 40 is constructed by the spark plug 18, the bias power supply 24 and the ion current measuring circuit 25. The bias power supply 24 is structured such as to apply a measuring voltage (a bias voltage) for measuring the ion current to the spark plug 18 at a point in time when the ignition pulse g disappears. Further, the ion current I flowing between an inner wall of the combustion chamber 30 and a center electrode of the sparkplug 18, and between the electrodes of the spark plug 18, on the basis of an application of the measuring voltage is measured by the ion current measuring circuit 25. The bias power supply 24 and the ion current measuring circuit 25 can employ various structures which have been well known in the field.

In the electronic control device 6, there is installed a program for injecting the fuel in correspondence to an engine load to the intake system 1 by correcting a basic injection time (a basic injection amount) on the basis of various correction coefficients decided in correspondence to the operating state of the engine 100 by mainly using the intake air pressure signal a output from the intake air pressure sensor 13 and the rotating speed signal b output from the cam position sensor 14 so as to decide a fuel injection valve opening time, that is, an injector final exciting time T, controlling the fuel injection valve 5 on the basis of the decided exciting time. Further, the electronic control device 6 is programmed in such a manner as to control the fuel injection of the engine 100 as mentioned above, detect the ion current I generated within the combustion chamber 30 per ignition, set at least two determination values having different magnitudes, individually measure the generation period in which the current value of the detected ion current I is greater than each of the predetermination values, and determine that the combustion state is normal in the case that the generation period measured in the case that the detected ion current I is greater than only the determination value which is lower than the highest determination value in the determination values is longer than the generation period measured on the basis of the highest determination value.

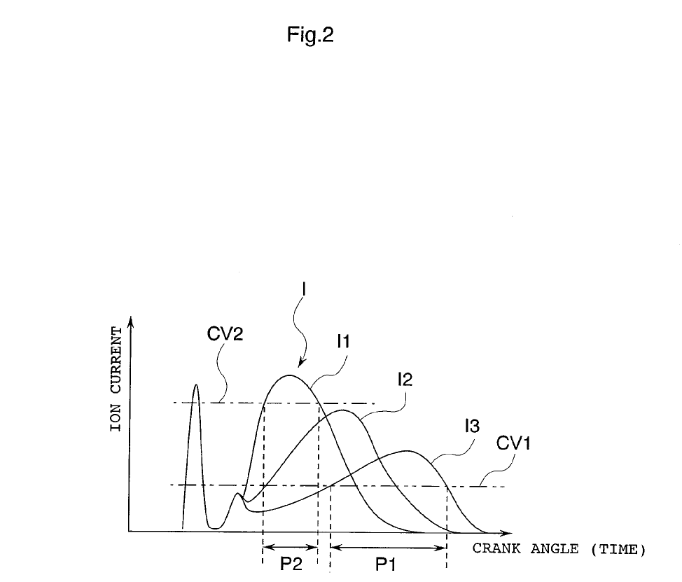

In the structure mentioned above, an outline of the combustion state determining program is shown in FIG. 2.

In this embodiment, there are set a first current determination value CV1 and a second current determination value CV2 which correspond to a determination reference for determining a current value corresponding to a characteristic value of the ion current I, and there are set a first period determination value TV1 and a second period determination value TV2 which correspond to a determination reference for determining generation periods P1 and P2. The first and second current determination values CV1 and CV2 and the first and second period determination values TV1 and TV2 are stored as a data of the combustion state determining program together with the program in a memory device 8 of an electronic control device 6.

Magnitudes of the first current determination value CV1 and the second current determination value CV2 are set such as to be capable of determining a combustion state (a good combustion state) in a normal operating state in which an ignition timing is retarded and a combustion state in the case that the ignition timing is retarded. In other words, as shown in I1, I2 and I3 in FIG. 2, they are set such as to be capable of identifying the ion current I indicating different wave forms in correspondence to with or without the spark retard of the ignition timing.

As shown in FIG. 2, the maximum value of the current value of the ion current I is changed in accordance with a degree of the spark retard of the ignition timing, and the period generating the iron current I, that is, the generation period is changed. Further, in the case of the normal combustion state in which the ignition timing is not retarded, the maximum value which is high such as I1 in FIG. 2 is exhibited. On the contrary, if the ignition timing is retarded, the maximum value becomes lowered in comparison with the case that the ignition timing is not retarded. Further, the respective maximum values become lowered such as I2 and I3 in FIG. 2 in correspondence to a degree of the spark retard, that is, an amount of the spark retard. In the case that the amount of the spark retard is medium, the maximum value becomes lowered such as I2 in FIG. 2 in comparison with the case that the ignition timing is not retarded, and if the amount of the spark retard is increased, the maximum value becomes further lowered such as I3 in FIG. 2. Accordingly, the first and second current determination values CV1 and CV2 are set in correspondence to the fact that the maximum value of the current value of the ion current I is different in accordance with the amount of the spark retard of the ignition timing.

In this embodiment, since the current value of the ion current I indicates the maximum value during a period when the elapsed time from the ignition is short, in the normal combustion state, the second current determination value CV2 is set high. Further, since the maximum value of the current value of the ion current I becomes lowered as well as being generated at a point in time which has passed for a long time from the ignition, in accordance that the amount of the spark retard of the ignition timing is increased, the first current determination value CV1 is set lower than the second current determination value CV2.

In correspondence to the first and second current determination values CV1 and CV2 mentioned above, the first period determination value TV1 is set such that the generation period P1 of the ion current I becomes longer, and the second period determination value TV2 is set such that the generation period P2 becomes shorter than that in the first period determination value TV1, respectively. In this case, the spark retard means retarding the ignition timing in comparison with the previous ignition timing, and retarding to the ignition timing which is retarded from the ignition timing of the most spark advance.

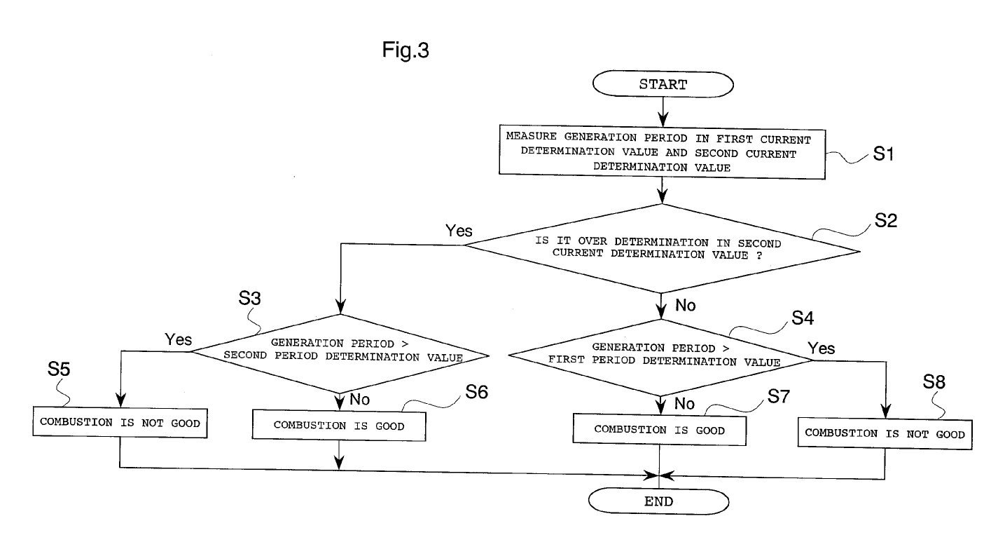

In FIG. 3, first, in the step S1, measured is the generation period P1 in which the current value of the ion current I detecting the generation is greater than the first current determination value CV1, and measured is the generation period P2 in which the current value is greater than the second current determination value CV2. In this case, in the case that the current value of the ion current I is low, the current value is not greater than the second current determination value CV2, and the generation period P2 measured on the basis of the second current determination value CV2 comes to zero. Further, in this case, the generation period P1 only on the basis of the first current determination value CV1 is measured. The generation periods P1 and P2 are measured, for example, on the basis of the crank angle. In this case, the generation periods P1 and P2 may be measured on the basis of an actual time.

In the step S2, it is determined whether or not the current value of the measured ion current I is greater than the second current determination value CV2, in other words, whether the generation period P2 is not zero. The determination is structured such as to determine whether the ion current I detected at this time corresponds to the normal combustion state, or corresponds to the operating state in which the ignition timing is retarded. In the case that in the step S2, it is determined that the current value of the ion current I is greater than the second current determination value CV2, the step S3 is subsequently executed, and the step S4 is executed in the other cases.

In the step S3, it is determined whether or not the generation period P2 measured in the step S1 is greater than the second period determination value TV2, the step S5 is executed in the case that the generation period is greater, and the step S6 is executed in the other cases. On the other hand, in the step S4, it is determines whether or not the generation period PI measured in the step S1 is greater than the first period determination value TV1, the step S7 is executed in the case that the generation period is greater, and the step S8 is executed in the other cases.

In the step S5, it is determined that the combustion state corresponding to the ion current I detected at this time on the basis of the result of determination of the step S3 is not good. In the step S6, it is determined that the combustion state is good. In the same manner, in the step S7, it is determined that the combustion state corresponding to the ion current I detected at this time on the basis of the result of determination of the step S4 is good. On the other hand, in the step S8, it is determined that the combustion state is not good.

In the structure mentioned above, if the engine 100 is operated, the ion current I is detected per ignition in each of the cylinders, the step SI and the step S2 are executed, and high and low of the current value of the ion current I is determined. Since the current value of the ion current I becomes higher in the case that the combustion state is good, the step S3 is executed after the determination of the step S2, and in the case that the generation period P2 of the ion current I measured at this time is equal to or less than the second period determination value TV2, as a result of the determination in the step S3, in the step S6, it is determined that the combustion state is good.

In other words, in the case that the engine 100 is operated without retarding the ignition timing and the air-fuel mixture is normally burnt, the current value of the detected ion current I rapidly rises up after the ignition and comes to the maximum value in a crank angle near a top dead center. Further, since the ion current I is attenuated after the current value becomes maximum, the ion current I is increased to a current value which is greater than the second current determination value CV2 during a short elapsed time, and is generated only a period in which the ion current I is equal to or lower than the second period determination value TV2.

On the contrary, in the case that the generation period P2 of the ion current I is a long time which is longer than the second period determination value TV2, in the step S5, it is determined that the combustion state is not good, in correspondence to the result of determination in the step S3. In other words, in this case, the detected ion current I is a current value which is greater than the second current determination value CV2 in the same manner as the case of the normal combustion state, however, the current value is generated greater than the second current determination value CV2 without descending to the second current determination value CV2 or lower on the basis of the elapse for the short time as mentioned above, and the generation period P2 is generated longer than the second period determination value TV2. Accordingly, since the current flows for a long time in a state in which the current value is high, for example, on the basis of an excessively rich air-fuel mixture or the like, it is determined that the combustion state is not good.

As described above, since it is possible to determine the combustion state on the basis of the length of the period in which the ion current is generated while being greater even in the case that the current value of the ion current I is generated greater than the second current determination value CV2, it is possible to securely determine only the case that the combustion state is good.

Next, in the case that the current value of the ion current I detected by executing the step S1 and the step S2 is equal to or less than the second current determination value CV2, the step S4 is executed. If the generation period P1 is equal to or less than the first period determination value TV1, in the step S7, it is determined that the combustion state is good, and in the case that the generation period P1 is longer than the first period determination value TV1, in the step S8, it is determined that the combustion state is not good.

Accordingly, even in the case that the current value of the ion current I becomes lower, and the generation period P1 becomes longer, it is possible to identify the good combustion state and the no-good combustion state. For example, in the case that the ion current I shows the state mentioned above on the basis of the spark retard of the ignition timing, when the current value of the ion current I is greater than only the first current determination value CV1, and the generation period P1 is longer than the generation period P2, it is possible to determine that the combustion state is good, if the generation period P1 is equal to or less than the first period determination value TV1. Further, for example, in the case that the air fuel ratio is excessively high, that is, the air-fuel mixture becomes excessively lean, the current value is low in the same manner as the case that the ignition timing is retarded, and the ion current I having the long generation period P is detected. However, in this case, since the generation period P1 is longer than the first period determination value TV1, it is possible to determine that the combustion state is not good.

As described above, it is possible to determine the combustion state in the various operating states by determining the current value of the ion current I on the basis of the first current determination value CV1 and the second current determination value CV2 and determining the generation periods P1 and P2 in correspondence to the current value, whereby it is possible to reduce the erroneous determination of the combustion state. Particularly, since it is possible to determine the combustion state in the operating state in which the ignition timing is retarded, in the case that the ignition timing is greatly retarded for activating the O₂ sensor 21 and the three-way catalyst 22 in an early time, at a time of the cold engine start, it is possible to prevent the operating state of the engine 100 from becoming unstable.

Further, since only two comprising the first current determination value CV1 and the second current determination value CV2 are set for measuring the generation periods P1 and P2 of the ion current I, it is possible to simplify the program.

It is to be noted that, the present invention is not limited to the embodiment mentioned above.

In the embodiment mentioned above, the description is given of the structure which determines the combustion state in the normal combustion state and the case that the ignition timing is retarded, however, it is possible to determine the combustion state in which the air fuel ratio is excessively leaner than the stoichiometric air fuel ratio, by utilizing the first and second current determination values CV1 and CV2 mentioned above.

Specifically, the structure measures the generation period of the ion current which is greater than the first and second current determination values CV1 and CV2. In this case, the crank angles at a start point and an end point of the measurement are stored. Next, it is determined whether or not the current value of the ion current I is greater than the second current determination value CV2, in a predetermined period, for example, until the piston passes through a bottom dead center from the first stage of the combustion, that is, the ignition. In this case, the determination is carried out on the basis of whether or not the crank angle at the end point in time of the generation period P is before the bottom dead center. In this determination, in the case of determining that the current value is not higher, it is determined whether or not the current value of the ion current I is greater than the first current determination value CV1 after a predetermined period, that is, after the piston reaches the bottom dead center. In the case that the current value of the ion current I is greater than the first current determination value CV1 and the generation period of the ion current is measured, it is determined that the combustion is biased to the bottom dead center or after, that is, a so-called after burning state, and the combustion state is unstable.

As described above, it is possible to determine the fact that the air fuel ratio is controlled to the lean side and the combustion state is unstable, by detecting the timing in which the current value of the ion current is greater than the current determination value, while utilizing the first and second current determination values CV1 and CV2. As described above, it is possible to reduce the fuel injection amount close to the limit of the lean burn control, for example, even in the operating state in which the O₂ sensor 21 is not yet activated at a time of the cold engine start, by determining the combustion state in the case of controlling the air fuel ratio to the lean side on the basis of the ion current, whereby it is possible to improve the emission of the exhaust gas as well as it is possible to improve the fuel consumption.

In the embodiment mentioned above, the current determination value determining the current value of the ion current I is constituted by two kinds of high and low current determination values, however, may be set to three kinds or more in correspondence to the maximum value of the current value of the ion current at a time of retarding the ignition timing. In other words, as shown in FIG. 2, since the maximum value of the current value of the ion current I is changed in accordance with the degree of the spark retard of the ignition timing, three kinds are set in the case of taking three kinds of ion currents into consideration such as FIG. 2.

Accordingly, it is possible to in detail determine the combustion state at a time of the spark retard, by setting three kinds or more current determination values in correspondence to the different maximum values of the current value of the ion current I in accordance with the amount of the spark retard of the ignition timing, and setting the same number of current determination values with respect to the period determination value for determining the generation period P, so that it is possible to accurately determine the combustion state even in the case that the amount of the spark retard is much and the generation period P of the ion current I becomes longer.

In the structure mentioned above, the current value is described as the characteristic value of the ion current I, however, the characteristic value may be constituted by a voltage generated in the case that the ion current I flows.

In addition, the particular structure of each of the portions is not limited to the embodiment mentioned above, but may be variously modified within the scope of the present invention.

### INDUSTRIAL APPLICABILITY

The present invention can be widely applied to the structure in which the ion current is generated by using the spark plug just after ignition. Further, in the internal combustion engine mentioned above, the present invention can accurately determine the combustion state on the basis of the characteristic value of the ion current and the generation period corresponding to the various operating states, and functions particularly effectively in the operating state in the case that the ignition timing is retarded.

1. A method for determining a combustion state of an internal combustion engine, for detecting an ion current generated within a combustion chamber of the internal combustion engine, comprising the steps of:
measuring a characteristic value of the ion current detected during a period that the ion current is generated and a generation period in which the ion current is generated; and
determining a combustion state on the basis of a relation between the characteristic value and the generation period with respect to an elapsed time from an ignition,
wherein the method comprises determining that the combustion state is normal, by setting a determination reference to be larger with respect to the characteristic value and shorter with respect to the generation period, in the case that the elapsed time from the ignition is short, and determining that the combustion is normal, by setting the determination reference to be smaller with respect to the characteristic value and longer with respect to the generation period in correspondence that the elapsed time from the ignition becomes longer.

2. A method for determining a combustion state of an internal combustion engine, for detecting an ion current generated within a combustion chamber of the internal combustion engine, comprising the steps of:
setting at least two determination values having different magnitudes;
individually measuring a generation period in which a current value of the detected ion current is greater than each of the determination values; and
determining that the combustion state is normal in the case that a generation period measured in the case that the detected ion current is greater than only a determination value which is lower than a highest determination value in the determination values is longer than a generation period measured on the basis of the highest determination value.

3. The method for determining a combustion state of an internal combustion engine according to claim 2, wherein the method comprises determining that the combustion state is unstable in the case of measuring the generation period only on the basis of the low determination value in a first stage of the combustion and thereafter measuring the period on the basis of the highest determination value in a second stage of the combustion.
